(19) United States
(12) Patent Application Publication
(10) Pub. No.: US 2025/0374000 A1
(43) Pub. Date: Dec. 4, 2025

(54) METHOD, APPARATUS, AND DEVICE FOR VIRTUALIZING EXTERNAL VEHICLE SOUND AND READABLE STORAGE MEDIUM

(71) Applicant: AAC Technologies (Nanjing) Co., Ltd., Nanjing City (CN)

(72) Inventors: Denglin Li, Nanjing (CN); Huan Ge, Nanjing (CN); Yuheng Jiang, Nanjing (CN); Hongxing Wang, Nanjing (CN)

(21) Appl. No.: 18/986,754

(22) Filed: Dec. 19, 2024

Related U.S. Application Data
(63) Continuation of application No. PCT/CN2024/097219, filed on Jun. 4, 2024.

(51) Int. Cl. H04S 7/00; G10K 11/178; H04R 3/00; H04R 5/027

(52) U.S. Cl. CPC H04S 7/302; G10K 11/17827; G10K 11/17885; H04R 3/005; H04R 5/027; G10K 2210/1282; H04R 2499/13; H04S 2400/11; H04S 2400/15

(57) ABSTRACT

Provided are a method, device, and apparatus for virtualizing an external vehicle sound, and readable storage medium. The method includes: controlling a vehicle external microphone to enter an external vehicle sound acquisition state when a vehicle is in a pass-through mode; generating an external vehicle sound virtualizing instruction according to a target external vehicle sound signal when an external vehicle sound signal is received in real-time; sending the external vehicle sound virtualizing instruction to in-vehicle speakers to control the in-vehicle speakers to output a virtual sound signal. The vehicle external microphones are used to acquire sound and the in-vehicle speakers are controlled to simulate the external vehicle sound, so that the exterior important sound information can be effectively received by a person inside the vehicle, thereby improving the safety of driving and the accessibility of the important voice information of the person outside the vehicle.

### CROSS-REFERENCE TO RELATED APPLICATIONS

This application is a continuation of International Application No. PCT/CN2024/097219, Jun. 4, 2024, the entire contents of which is incorporated herein by reference.

### TECHNICAL FIELD

The present application relates to the field of speech processing technologies, in particular to a method, apparatus, and device for virtualizing an external vehicle sound and a readable storage medium.

### BACKGROUND

With the continuous development of the automobile industry, automobile performance has been significantly improved, and sound insulation and noise reduction performance as important performances have been widely considered by users. However, although the improvement of automotive sound insulation and noise reduction performance can bring users a quiet driving and riding experience, the blind pursuit of sound insulation and noise reduction performance will also bring certain negative impacts, the main negative impact is blocking the vehicle occupants of the vehicle external sound perception channel, resulting in the vehicle occupants can not effectively perceive the external vehicle sound information, such as car honking, outside the vehicle, such as the sound of people talking, so that the driving safety cannot be fully guaranteed, and it is easy to miss the important information conveyed by the person outside the car.

It should be noted that the techniques described in this section are not necessarily those that have been previously envisioned or adopted. Unless otherwise indicated, it should not be assumed that any of the technology described in this part is considered prior art merely because it is included in this part. Similarly, unless otherwise indicated, the issues referred to in this part should not be assumed to be recognized in any prior art.

### SUMMARY

The present application provides a method, apparatus, and device for virtualizing an external vehicle sound, and a readable storage medium, aiming to solve, at least to some extent, one of the problems in the related art.

In order to solve the above technical problems, a first aspect of the present application provides a method for virtualizing an external vehicle sound, comprising:
controlling a vehicle external microphone to enter an external vehicle sound acquisition state when a vehicle is in a pass-through mode;
generating an external vehicle sound virtualizing instruction according to a target external vehicle sound signal when an external vehicle sound signal acquired by the vehicle external microphone is received in real-time; and
sending the external vehicle sound virtualizing instruction to in-vehicle speakers; wherein the external vehicle sound virtualizing instruction is used to control the in-vehicle speakers to output a virtual sound signal corresponding to the target external vehicle sound signal.

A second aspect of the present application provides an apparatus for virtualizing an external vehicle sound, comprising:
a sound acquisition module configured to control a vehicle external microphone to enter an external vehicle sound acquisition state when a vehicle is in a pass-through mode;
an instruction generation module configured to generate an external vehicle sound virtualizing instruction according to a target external vehicle sound signal when an external vehicle sound signal acquired by the vehicle external microphone is received in real-time; and
an instruction sending module configured to send the external vehicle sound virtualizing instruction to in-vehicle speakers; wherein the external vehicle sound virtualizing instruction is used to control the in-vehicle speakers to output a virtual sound signal corresponding to the target external vehicle sound signal.

A third aspect of the present application provides an electronic device comprising: a memory and a processor, wherein the processor is configured to execute a computer program stored on the memory; and the processor, when executing the computer program, is configured to realize the respective steps in the method for virtualizing the external vehicle sound provided in the first aspect of the present application.

A fourth aspect of the present application provides a computer-readable storage medium having a computer program stored thereon, wherein the computer program, when executed by the processor, realizes the respective steps in the above-described method for virtualizing sound outside a vehicle provided in the first aspect of the present application.

As can be seen from the above, according to the method, apparatus, device for virtualizing the external vehicle sound, and readable storage medium provided in the present application, when the vehicle is in the pass-through mode, a vehicle external microphone of the vehicle is controlled to enter an external vehicle sound acquisition state; an external vehicle sound virtualizing instruction is generated according to a target external vehicle sound signal when an external vehicle sound signal acquired by the vehicle external microphone is received in real-time; and the external vehicle sound virtualizing instruction is sent to in-vehicle speakers to control the in-vehicle speakers to output a virtual sound signal corresponding to the target external vehicle sound signal. Through the implementation of the present application, the use of an exterior microphone to acquire the sound and then control the in-vehicle speakers to simulate the output of the external vehicle sound, so that the exterior important sound information can be effectively received by the person inside the vehicle who is in the sound insulation and noise reduction environment, thereby improving the driving safety and accessibility of the important voice information of the person outside the vehicle.

It should be understood that the contents described in this part are not intended to identify key or important features of the present application, nor are they intended to limit the scope of the present application. Other features of the present application will be readily understood by the following specification.

### BRIEF DESCRIPTION OF THE DRAWINGS

The accompanying drawings illustrate exemplary embodiments and form part of the specification, and are used in conjunction with the textual description of the specification to explain exemplary implementations of the embodiments. The accompanying drawings are shown for exemplary purposes only and do not limit the scope of the claims. In all of the accompanying drawings, the same reference signs refer to similar, but not necessarily identical, elements.

FIG. 1 shows a schematic diagram of a basic flowchart of a method for virtualizing an external vehicle sound according to an embodiment of the present application.

FIG. 2 shows a schematic diagram of the hardware architecture of an acoustic system according to an embodiment of the present application.

FIG. 3 shows a schematic diagram of the hardware architecture of another acoustic system according to an embodiment of the present application.

FIG. 4 shows a schematic diagram of a refined flowchart of a method for virtualizing an external vehicle sound according to an embodiment of the present application.

FIG. 5 shows a schematic diagram of a functional module of an apparatus for virtualizing an external vehicle sound according to an embodiment of the present application.

FIG. 6 shows a schematic diagram of the hardware structure of an electronic device according to an embodiment of the present application.

### DETAILED DESCRIPTION OF THE EMBODIMENTS

In order to make the inventive purpose, features, and advantages of the present application more obvious and understandable, the technical solutions in the embodiments of the present application will be described clearly and completely in the following in conjunction with the accompanying drawings in the embodiments of the present application. Obviously, the described embodiments are only a part of the embodiments of the present application, not all of the embodiments. According to the embodiments in the present application, all other embodiments obtained by the technical personnel in the field without making creative labor are within the scope of protection of the present application.

In the description of the embodiments of the present application, the terms “first” and “second” are used for descriptive purposes only, and are not to be understood as indicating or implying relative importance or implicitly specifying the number of the indicated technical features. Thus, the features limited to “first” or “second” may include, expressly or impliedly, one or more such features. The term “more than one” means two or more, unless otherwise expressly and specifically limited. The term “includes” indicates the presence of the described feature, whole, step, operation, element, and/or component, but does not preclude the presence or addition of one or more other features, wholes, steps, operations, elements, components, and/or collections thereof. The term “and/or” describes the association relationship of the associated objects, indicating that there may be three kinds of relationships, for example, A and/or B may include the existence of A alone, the existence of A and B at the same time, and the existence of B alone. The character “/” generally indicates that the associated objects before and after belong to the relationship of “or”.

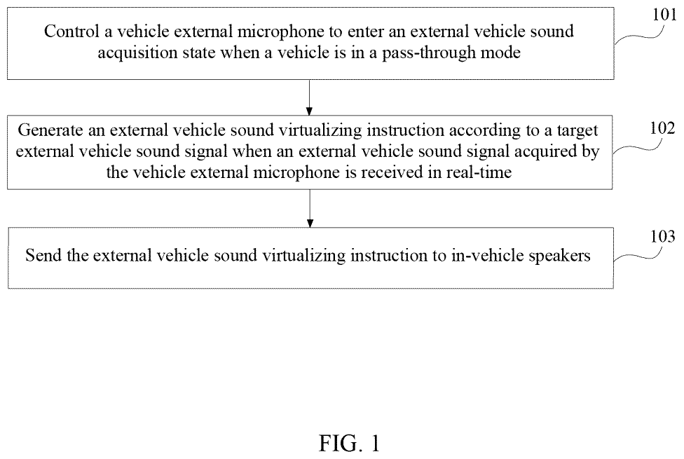

In order to solve the problem that a vehicle cabin with excellent sound insulation and noise reduction performance in the related art reduces the ability of the vehicle occupants to perceive the external vehicle sound, an embodiment of the present application provides a method for virtualizing an external vehicle sound, which may be applied to a vehicle terminal or a driver's mobile terminal. As shown in FIG. 1, which is a basic flowchart of a method for virtualizing the external vehicle sound provided in the embodiment, the method for virtualizing the external vehicle sound includes the following steps.

Step 101, when the vehicle is in the pass-through mode, a vehicle external microphone is controlled to enter an external vehicle sound acquisition state.

Specifically, the pass-through mode of the embodiment has certain triggering conditions, such as being triggered manually in response to a user operation or being triggered automatically according to specific detection data. In the pass-through mode of the embodiment, the speaker set inside the vehicle is allowed to simulate the output of the external vehicle sound signal, so as to cause the external vehicle sound to be replayed in the vehicle. It is to be noted that the vehicle external microphone of the embodiment refers to microphones set outside the body of the vehicle, and the number of vehicle external microphones is greater than or equal to one, and the specific number of and the setting location of the microphones may be determined depending on the actual use requirements.

In some implementations of the embodiment, before the above step of controlling the vehicle external microphone to enter the external vehicle sound acquisition state when the vehicle is in the pass-through mode, the method further includes the following steps: a current scene of the vehicle is identified according to sensor data collected by a vehicle sensor in real-time; and the pass-through mode is turned on when the current scene of the vehicle meets a condition for turning on the pass-through mode.

Specifically, as previously described, the vehicle occupants (e.g., drivers, and passengers) may manually trigger the pass-through mode through specific operations. In order to improve the triggering convenience, accuracy, and timeliness, data are collected in real-time or periodically by using sensors set up in the vehicle in this embodiment, and then the sensor data is analyzed to identify the scene where the vehicle is currently located, and the pass-through mode is turned on only if the scene where the vehicle is currently located meets the specific scene. It should be understood that the sensor data of the embodiment may include, but is not limited to, GPS data, environmental image data, and vehicle speed, and the specific scenes limited by the opening conditions of the pass-through mode include but are not limited to, any one or more of an ambient low-visibility scene, a high-complexity driving scene (e.g., backing up, cornering, a roadway with many obstacles, etc.), and a low-speed driving scene. It is worth mentioning that, in ambient low visibility scenarios and high complexity driving scenarios, the driving difficulty is relatively high for vehicle drivers, and comprehensive attention to the relevant information in the scenarios can effectively reduce the driving danger, thus it is necessary to trigger the pass-through mode in these scenarios. In addition, the vehicle in a high-speed driving state, the wind noise, tire noise, road noise, and other noises outside the vehicle are particularly large, the vehicle occupants have a relatively strong demand for sound insulation and noise reduction, and the high-speed driving state usually results in a lower signal-to-noise ratio of the external vehicle sound signal captured by the external vehicle microphone, so that there is less effective information in the captured external vehicle sound signal, and it is not sufficient for the effective external vehicle sound information to be replayed inside the vehicle, so the present embodiment may limit the pass-through mode on condition to a low-speed driving scenario.

Further, in some implementations of the embodiment, the above step of turning on the pass-through mode includes: determining, from a plurality of pre-configured pass-through modes, a pass-through mode of a target type corresponding to the current scene of the vehicle; turning on the pass-through mode of the target type.

Specifically, in this embodiment, the plurality of pre-configured pass-through modes have different external vehicle sound acquisition modes and/or external vehicle sound virtualization modes, and the external vehicle microphones and microphone operating states required to be triggered by the different external vehicle sound acquisition modes are different, which is specifically reflected in the fact that the position and/or number of the external vehicle microphones of the vehicle that enter the external vehicle sound acquisition state are different or the microphones have different sustained sampling lengths. The in-vehicle speakers and speaker operating states required to be triggered by different external vehicle sound virtual modes are different, which is specifically reflected in the fact that the different positions and/or numbers of the in-vehicle speakers that enter the virtual sound signal output, or the different playback volumes and cycle times of the speakers. The embodiment intelligently recognizes the scene in which the vehicle is located and adaptively adjusts the type of pass-through mode accordingly, so that the optimal experience can be provided to the user in different scenes.

Step 102, when an external vehicle sound signal acquired by the vehicle external microphone is received in real-time, an external vehicle sound virtualizing instruction is generated according to the target external vehicle sound signal.

Specifically, in the embodiment, after receiving the signal acquired by the microphones, the microphone-acquired signal may be first pre-processed, including but not limited to, automatic gain control, noise reduction processing, amplification processing, and the like, and then the operation of generating the external vehicle sound virtualizing instruction is performed according to the processed sound signal. It should be noted that the signal processing function of the embodiment may be realized according to the main chip of the vehicle platform, or may be realized according to the audio Digital Signal Processor (DSP) commonly used in the vehicle. Of course, it may be realized according to an additional DSP processor, and the embodiment is not uniquely limited herein.

In some implementations of the embodiment, before the above step of generating the external vehicle sound virtualizing instruction according to the target external vehicle sound signal, the method further includes: obtaining an actual signal-to-noise ratio of the external vehicle sound signal; determining a corresponding noise reduction processing level according to a signal-to-noise ratio level of the actual signal-to-noise ratio; and performing a noise reduction processing on the external vehicle sound signal according to the noise reduction processing level to obtain the target external vehicle sound signal.

Specifically, in practical application, when the environment in which the vehicle is located is relatively noisy, there is a large noise in the sound signal outside the vehicle captured by the vehicle external microphones, which leads to difficulty in restoring a relatively pure and effective sound signal inside the vehicle when the external vehicle sound signal is subsequently virtualized. According to this consideration, in this embodiment, a corresponding level of noise reduction is performed according to the signal-to-noise ratio of the external vehicle sound signal captured by the vehicle external microphones, whereby a target external vehicle sound signal with effective sound signal enhancement is obtained.

In some implementations of the embodiment, before the above step of generating the virtual instruction for the external vehicle sound according to the target external vehicle sound signal, it further includes: identifying sub-sound signals in the external vehicle sound signal that are respectively attributed to different sound sources according to the signal feature information; and filtering the target sub-sound signal to be determined as the target external vehicle sound signal from the plurality of sub-sound signals.

Specifically, there may be multiple sound sources in the surrounding environment of the vehicle. For example, in the vehicle's main driver's seat and the rear of the vehicle, there are relevant people at the same time and sound, however, not all the sound sources corresponding sound signals are in line with the needs of the vehicle personnel to receive the sound signal, that is to say, there are irrelevant sound signals. If all the corresponding sound signals of the sound sources are simulated and replayed in the vehicle, the irrelevant sound signals will have unnecessary interference with the vehicle personnel. According to this, in the embodiment, after receiving the sound signals collected by the vehicle external microphones, the corresponding sub-sound signals of the different sound sources are identified according to signal characteristic information, which may include signal amplitude, signal-associated microphone identifier, and the like. As an example, the sound sources that have different distances from the vehicle personnel can be identified according to the signal amplitude, and the sound sources that have different orientations to the vehicle are identified according to the signal-associated microphone identifier. Finally, a specific sub-sound signal can be screened from the identified different sub-sound signals as the target external vehicle sound signal to be simulated and replayed, and irrelevant sound signals will be screened out. For example, only the corresponding sub-sound signal of the sound source closest to the occupants of the vehicle can be taken as the target external vehicle sound signal, and only the corresponding sub-sound signal of the sound source close to the main driver's seat can be taken as the target external vehicle sound signal.

Step 103: an external vehicle sound virtualizing instruction is sent to in-vehicle speakers.

Specifically, the external vehicle sound virtualizing instruction of this embodiment is used to control the in-vehicle speakers to output a virtual sound signal corresponding to the target external vehicle sound signal. It is to be noted that the in-vehicle speakers may directly output the target external vehicle sound signal, or they may output the processed virtual sound signal after the target external vehicle sound signal is processed in a certain manner. The specific processing of the speaker signal includes but is not limited to, any one or more of equalization processing, dynamic control processing, gain control, and time delay control. As a result, the external vehicle sound is accurately restored in the vehicle, so that the vehicle occupants can still perceive the relevant sound outside the vehicle under the soundproof and noise-reducing vehicle environment. It is worth mentioning that the number and position of the in-vehicle speakers of the embodiment may be flexibly set according to the actual application scenario or usage requirements. Furthermore, the in-vehicle speakers may be the speakers configured in the vehicle itself, or they may be a part of the in-vehicle audio system that is multiplexed, or they may be a specialized speaker additionally configured in the vehicle. Of course, the in-vehicle speakers may also be the speakers configured on a user terminal interconnected with the in-vehicle terminal/car system.

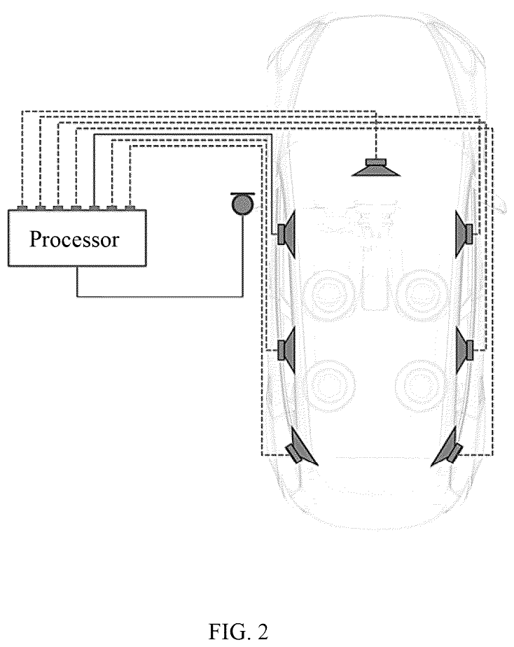

FIG. 2 is a schematic diagram of a hardware architecture of an acoustic system according to an embodiment, where 201 represents a microphone and 202 represents a speaker. In this hardware architecture, the vehicle exterior is configured with a single microphone, which may be arranged at any location such as the body or roof. In addition, the vehicle interior is configured with a plurality of speakers. In practice, after the external vehicle sound signal captured by the single vehicle exterior microphone is uploaded to a processor, the processor generates an external vehicle sound virtualizing instruction and then sends it to one or more of all the speakers to perform external vehicle sound reproduction through a particular speaker or all of the speakers for external vehicle sound playback.

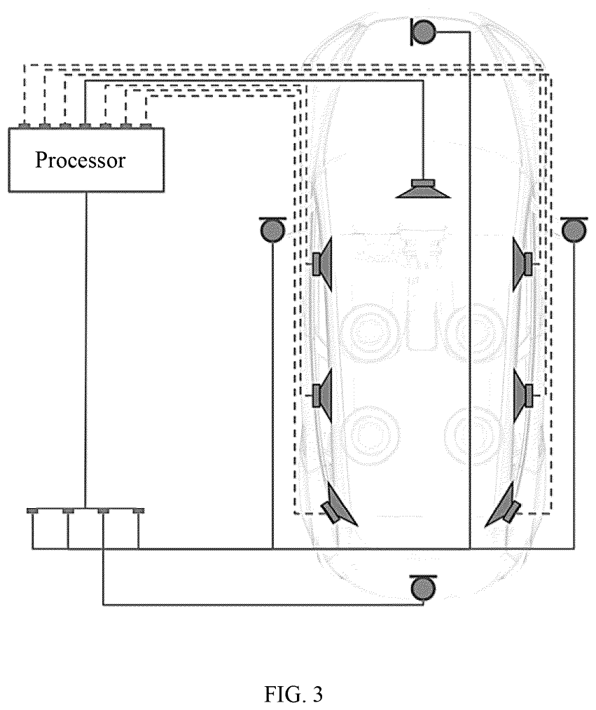

FIG. 3 is a schematic diagram of the hardware architecture of another acoustic system according to an embodiment, where 301 represents a microphone and 302 represents a speaker. In this hardware architecture, the vehicle exterior is configured with a plurality of microphones, which may be arranged at a plurality of different locations in the vehicle body and/or roof, such as the front, rear, left, and right sides of the vehicle body are all provided with a microphone for collecting sound signals outside the vehicle in different directions. Furthermore, the vehicle interior is configured with a plurality of speakers similar to the hardware architecture shown in FIG. 2 for performing the sound playback of the external vehicle sound through a specific speaker or all the speakers.

In some implementations of the embodiment, the step of generating the external vehicle sound virtualizing instruction according to the target external vehicle sound signal includes: determining an actual external vehicle sound source orientation corresponding to the target external vehicle sound signal; and determining a corresponding in-vehicle virtual sound source orientation according to the actual external vehicle sound source orientation. Correspondingly, the step of sending the external vehicle sound virtualizing instruction to the in-vehicle speakers of the vehicle includes: sending the external vehicle sound virtualizing instruction to an in-vehicle speaker corresponding to the in-vehicle virtual sound source orientation.

Specifically, according to the hardware architecture shown in FIG. 3, in practical applications, the actual external vehicle sound source orientation may be determined according to the external vehicle sound signals captured by the plurality of vehicle external microphones, and the in-vehicle speakers in the corresponding in-vehicle virtual sound source orientation is controlled to playback the external vehicle sound, which can enable the vehicle occupants to perceive the external vehicle sound while also being informed of the orientation in which the external vehicle sound source is located.

In some implementations of the embodiment, the step of determining the actual external vehicle sound source orientation corresponding to the target external vehicle sound signal includes: obtaining an external vehicle sound signal acquired by each of the plurality of the vehicle external microphones; determining the target external vehicle sound signal and the target vehicle external microphone corresponding to the target external vehicle sound signal according to signal attributes of the plurality of the external vehicle sound signals; wherein the signal attributes comprise at least one of the following: a signal amplitude value, a signal delay value; determining the actual external vehicle sound source orientation corresponding to the target external vehicle sound signal according to a configured orientation of the target vehicle external microphone.

Specifically, in a practical application scenario, the signal attributes of the sound signals collected by the vehicle external microphones at different locations for the same sound source are different, and the signal amplitude value of the sound signal collected by the vehicle external microphone closest to the sound source has the largest signal amplitude value and the smallest signal delay value, so that the location of the vehicle external microphone can be approximated as the actual external vehicle sound source orientation. It should be understood that all the sound signals collected by multiple vehicle external microphones in a realistic scenario may originate from multiple sound sources, i.e., it is not guaranteed that all the sound signals are valid sound signals. Thus, in the embodiment, it is also possible to first filter the valid sound signals based on the signal attributes of each sound signal as the target external vehicle sound signal that needs to be restored in the vehicle.

In some implementations of the embodiment, the step of sending the external vehicle sound virtualizing instruction to the in-vehicle speaker corresponding to the in-vehicle virtual sound source orientation includes: determining an in-vehicle spatial location to be covered by the virtual sound signal; determining a corresponding in-vehicle speaker in combination with the in-vehicle spatial location and the in-vehicle virtual sound source orientation; and sending the external vehicle sound virtualizing instruction to the in-vehicle speaker.

Specifically, the vehicle usually includes a driver's seat and a plurality of passenger seats, and the vehicle occupants who need to perform sound perception may vary in different scenarios, thus, in order to further enhance the user's experience of sound perception, in this embodiment, specific in-vehicle speakers will be determined from the plurality of in-vehicle speakers for the simulation output of the external vehicle sound according to the specific spatial location of the external vehicle sound to be restored inside the vehicle as well as the previously determined the in-vehicle virtual sound source orientation. It is to be noted that in the embodiment, in the step of determining the specific in-vehicle speaker according to the in-vehicle virtual sound source orientation, a single speaker at the in-vehicle virtual sound source orientation may be taken as the specific in-vehicle speaker for which the external vehicle sound virtualizing instruction to be sent, or the two speakers on both sides of the in-vehicle virtual sound source orientation are taken as the specific in-vehicle speakers for which the external vehicle sound virtualizing instruction to be sent.

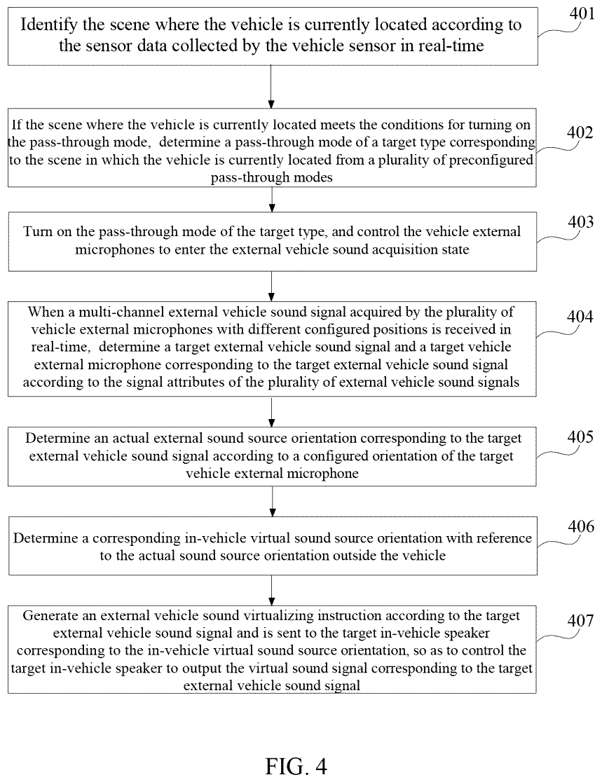

The method in FIG. 4 is a refined method for virtualizing the external vehicle sound according to an embodiment of the present application, which specifically includes the following steps.

Step 401, the scene where the vehicle is currently located is identified according to the sensor data collected by the vehicle sensor in real-time;

Step 402, if the scene where the vehicle is currently located meets the conditions for turning on the pass-through mode, a pass-through mode of a target type corresponding to the scene in which the vehicle is currently located is determined from a plurality of preconfigured pass-through modes;

Step 403, the pass-through mode of the target type is turned on, and the vehicle external microphones are controlled to enter the external vehicle sound acquisition state;

Step 404, when a multi-channel external vehicle sound signal acquired by the plurality of vehicle external microphones with different configured positions is received in real-time, a target external vehicle sound signal and a target vehicle external microphone corresponding to the target external vehicle sound signal are determined according to the signal attributes of the plurality of external vehicle sound signals;

Step 405: an actual external sound source orientation corresponding to the target external vehicle sound signal is determined according to a configured orientation of the target vehicle external microphone;

Step 406, a corresponding in-vehicle virtual sound source orientation is determined with reference to the actual sound source orientation outside the vehicle;

Step 407, an external vehicle sound virtualizing instruction is generated according to the target external vehicle sound signal and is sent to the target in-vehicle speaker corresponding to the in-vehicle virtual sound source orientation, so as to control the target in-vehicle speaker to output the virtual sound signal corresponding to the target external vehicle sound signal.

It should be understood that the size of the serial numbers of the steps in the embodiment does not imply the sequence of the order of execution of the steps, and the order of execution of the steps should be determined by their functions and intrinsic logic without constituting a sole limitation on the implementation process of the embodiments of the present application.

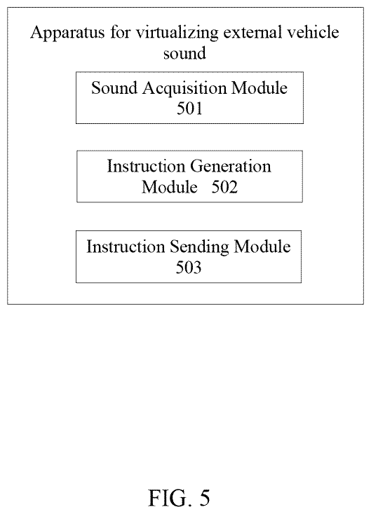

FIG. 5 shows an apparatus for virtualizing an external vehicle sound according to an embodiment of the present application. The apparatus may be used for realizing the method for virtualizing the external vehicle sound in the foregoing embodiment, mainly including:
a sound acquisition module 501 configured to control a vehicle external microphone to enter an external vehicle sound acquisition state when a vehicle is in a pass-through mode;
an instruction generation module 502 configured to generate an external vehicle sound virtualizing instruction according to a target external vehicle sound signal when an external vehicle sound signal acquired by the vehicle external microphone is received in real-time; and
an instruction sending module 503 configured to send the external vehicle sound virtualizing instruction to in-vehicle speakers. The external vehicle sound virtualizing instruction is used to control the in-vehicle speakers to output a virtual sound signal corresponding to the target external vehicle sound signal.

In an implementation of the embodiment, the apparatus further includes a mode opening module configured to identify a current scene of the vehicle according to sensor data collected by a vehicle sensor in real-time; and turn on the pass-through mode when the current scene of the vehicle meets a condition for turning on the pass-through mode.

In an implementation of the embodiment, the apparatus further includes a signal processing module configured to obtain an actual signal-to-noise ratio of the external vehicle sound signal; determine a corresponding noise reduction processing level according to a signal-to-noise ratio level of the actual signal-to-noise ratio; and perform a noise reduction processing on the external vehicle sound signal according to the noise reduction processing level to obtain the target external vehicle sound signal.

It should be noted that the method for virtualizing the external vehicle sound in the foregoing method embodiments may be realized by the apparatus for virtualizing the external vehicle sound provided in this embodiment. A person of ordinary skill in the art can clearly understand that, for the convenience and brevity of the description, the specific work process of the virtual device for the sound outside the vehicle described in this embodiment can be realized with reference to the corresponding work process in the preceding method embodiments, and will not be repeated herein.

According to the above-described technical solution of the embodiment of the present application, when the vehicle is in the pass-through mode, the vehicle external microphones are controlled to enter an external sound acquisition state; an external vehicle sound virtualizing instruction is generated according to the target external vehicle sound signal when the external vehicle sound signal acquired by the vehicle external microphones is received in real-time; and the external vehicle sound virtualizing instruction is sent to the in-vehicle speakers so as to control the in-vehicle speakers to output a virtual sound signal corresponding to the target external sound signal. Through the implementation of the present application, the vehicle external microphones are used to acquire sound and then the in-vehicle speakers are controlled to simulate the output of the external vehicle sound, so that the exterior important sound information can be effectively received by a person inside the vehicle under a soundproof and noise reduction environment, thereby improving the safety of driving and the accessibility of the important voice information of the person outside the vehicle.

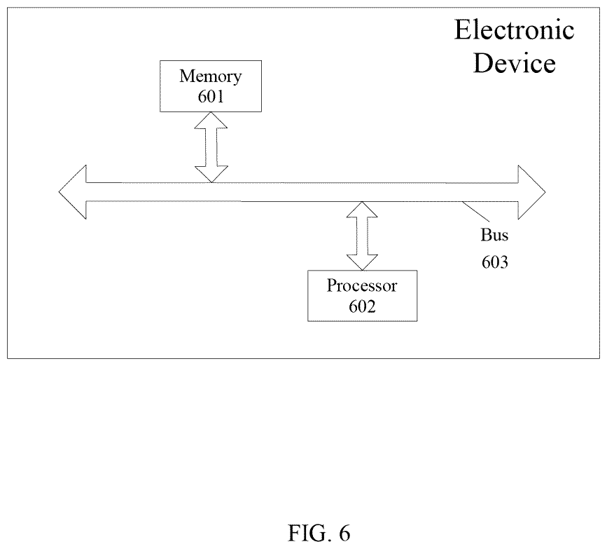

Referring to FIG. 6, which shows an electronic device according to an embodiment of the present application. The electronic device may be used to realize the method for virtualizing the external vehicle sound in the preceding embodiment. As shown in FIG. 6, the electronic device mainly includes:
a memory 601, a processor 602, and a bus 603. The memory 601 and the processor 602 are connected through the bus 603. The memory 601 stores a computer program that can be run on the processor 602, and the processor 602, when executing the computer program, implements the method for virtualizing the external vehicle sound in the preceding embodiment. The number of processors may be one or more.

The memory 601 may be a high-speed random-access memory (RAM), or a non-volatile memory, such as a disk memory. The memory 601 is configured to store executable program code, and the processor 602 is coupled to the memory 601.

Further, embodiments of the present application also provide a computer-readable storage medium, which may be provided in an electronic device in each of the foregoing embodiments. The computer-readable storage medium may be a memory in the embodiment shown in FIG. 6.

The computer-readable storage medium stores a computer program. The computer program, when executed by a processor, implements the method for virtualizing the external vehicle sound in the foregoing embodiments. Further, the computer-readable storage medium may also be a USB flash drive, a removable hard disk, a read-only memory (ROM), a RAM, a magnetic disk, a CD-ROM, and various other media that can store the program code.

In the several embodiments provided in the present application, it should be understood that the apparatuses and methods disclosed, may be realized in other ways. For example, the above-described embodiments of the apparatus are merely schematic, e.g., the division of modules, which is merely a logical functional division, may be divided in other ways when actually implemented, e.g., multiple modules or components may be combined or may be integrated into another system, or some features may be ignored, or not implemented. At another point, the mutual coupling, direct coupling or communication connection shown or discussed may be an indirect coupling or communication connection through some interface, device, or module, which may be electrical, mechanical, or otherwise.

The modules illustrated as separate components may or may not be physically separate, and the components shown as modules may or may not be physical modules, i.e., they may be located in a single place or they may be distributed to a plurality of network modules. Some or all of these modules may be selected to fulfill the purpose of the embodiment scheme according to actual needs.

In addition, the various functional modules in the various embodiments of the present application may be integrated in a single processing module, or the individual modules may be physically present separately, or two or more modules may be integrated in a single module. The above integrated modules may be implemented either in the form of hardware or in the form of software function modules.

The integrated modules, when implemented in the form of software function modules and sold or used as separate products, may be stored in a computer-readable storage medium. According to this understanding, the technical solution of the present application is essentially, or in part, a contribution to the prior art, or all or part of the technical solution may be embodied in the form of a software product. The computer software product is stored in a readable storage medium including a number of instructions to cause a computer device (which may be a personal computer, a server, or a network device, etc.) to perform all or part of the steps of the methods of various embodiments of the present application. The aforementioned readable storage medium includes a USB flash drive, a removable hard disk, a ROM, a RAM, a diskette, a CD-ROM, and other media that can store program code.

It is to be noted that the aforementioned method embodiments are expressed as a series of action combinations for the sake of simplicity of description, but the person skilled in the art should be aware that the present application is not limited by the order of the described actions. According to the present application, some of the steps may be carried out in a different order or at the same time. Secondly, the person skilled in the art should also be aware that the embodiments described in the specification are preferable embodiments, and the actions and modules involved are not necessarily necessary for the present application.

In the above embodiments, the description of each embodiment has its own focus, and the part that is not described in detail in a certain embodiment may be referred to the relevant description of other embodiments.

The above is a description of the method, apparatus, device, and readable storage medium for virtualizing the external vehicle sound provided in the present application. For the technical personnel in the field, according to the ideas of the embodiments of the present application, there will be changes in the specific implementation and application scope, and in summary, the contents of this specification should not be construed as a limitation of the present application.

What is claimed is:

1. A method for virtualizing an external vehicle sound, comprising:
controlling a vehicle external microphone to enter an external vehicle sound acquisition state when a vehicle is in a pass-through mode;
generating an external vehicle sound virtualizing instruction according to a target external vehicle sound signal when an external vehicle sound signal acquired by the vehicle external microphone is received in real-time; and
sending the external vehicle sound virtualizing instruction to in-vehicle speakers; wherein the external vehicle sound virtualizing instruction is used to control the in-vehicle speakers to output a virtual sound signal corresponding to the target external vehicle sound signal.

2. The method for virtualizing the external vehicle sound of claim 1, further comprising:
identifying a current scene of the vehicle according to sensor data collected by a vehicle sensor in real-time; and
turning on the pass-through mode when the current scene of the vehicle meets a condition for turning on the pass-through mode.

3. The method for virtualizing the external vehicle sound of claim 2, wherein the step of turning on the pass-through mode comprises:
determining, from a plurality of pre-configured pass-through modes, a pass-through mode of a target type corresponding to the current scene of the vehicle; wherein the plurality of the pre-configured pass-through modes have different external vehicle sound acquisition modes and/or external vehicle sound virtualization modes; and
turning on the pass-through mode of the target type.

4. The method for virtualizing the external vehicle sound of claim 1, wherein before generating the external vehicle sound virtualizing instruction according to the target external vehicle sound signal, the method further comprises:
obtaining an actual signal-to-noise ratio of the external vehicle sound signal;
determining a corresponding noise reduction processing level according to a signal-to-noise ratio level of the actual signal-to-noise ratio; and
performing a noise reduction processing on the external vehicle sound signal according to the noise reduction processing level to obtain the target external vehicle sound signal.

5. The method for virtualizing the external vehicle sound of claim 1, wherein the step of generating the external vehicle sound virtualizing instruction according to the target external vehicle sound signal comprises:
determining an actual external vehicle sound source orientation corresponding to the target external vehicle sound signal; and
determining a corresponding in-vehicle virtual sound source orientation according to the actual external vehicle sound source orientation;
the step of sending the external vehicle sound virtualizing instruction to the in-vehicle speakers comprises:
sending the external vehicle sound virtualizing instruction to an in-vehicle speaker corresponding to the in-vehicle virtual sound source orientation.

6. The method for virtualizing the external vehicle sound of claim 5, wherein the vehicle is provided with a plurality of the vehicle external microphones configured in different positions; the step of determining the actual external vehicle sound source orientation corresponding to the target external vehicle sound signal comprises:
obtaining an external vehicle sound signal acquired by each of the plurality of the vehicle external microphones;
determining the target external vehicle sound signal and the target vehicle external microphone corresponding to the target external vehicle sound signal according to signal attributes of the plurality of the external vehicle sound signals; wherein the signal attributes comprise at least one of the following: a signal amplitude value and a signal delay value;
determining the actual external vehicle sound source orientation corresponding to the target external vehicle sound signal according to a configured orientation of the target vehicle external microphone.

7. The method for virtualizing the external vehicle sound of claim 5, wherein the vehicle is provided with a plurality of the in-vehicle speakers configured in different configured positions; the step of sending the external vehicle sound virtualizing instruction to the in-vehicle speaker corresponding to the in-vehicle virtual sound source orientation comprises:
determining an in-vehicle spatial location to be covered by the virtual sound signal;
determining a corresponding in-vehicle speaker in combination with the in-vehicle spatial location and the in-vehicle virtual sound source orientation; and
sending the external vehicle sound virtualizing instruction to the in-vehicle speaker.

8. An apparatus for virtualizing an external vehicle sound, comprising:
a sound acquisition module configured to control a vehicle external microphone to enter an external vehicle sound acquisition state when a vehicle is in a pass-through mode;
an instruction generation module configured to generate an external vehicle sound virtualizing instruction according to a target external vehicle sound signal when an external vehicle sound signal acquired by the vehicle external microphone is received in real-time; and
an instruction sending module configured to send the external vehicle sound virtualizing instruction to in-vehicle speakers; wherein the external vehicle sound virtualizing instruction is used to control the in-vehicle speakers to output a virtual sound signal corresponding to the target external vehicle sound signal.

9. An electronic device, comprising a memory, and a processor;
wherein the processor is configured to execute a computer program stored on the memory;
and the processor, when executing the computer program, is configured to realize the steps in the method for virtualizing the external vehicle sound of claim 1.
